(19) United States
(12) Patent Application Publication
(10) Pub. No.: US 2022/0388907 A1
(43) Pub. Date: Dec. 8, 2022

(54) CEMENT SHEETS AND COATINGS FOR BUILDING CONSTRUCTION

(71) Applicant: SHAKED ADDITIVES LTD., Moshav Haniel (IL)

(72) Inventors: Rotem BARZILAY, Moshav Haniel (IL); Zvi BARZILAY, Moshav Haniel (IL)

(73) Assignee: SHAKED ADDITIVES LTD., Moshav Haniel (IL)

(21) Appl. No.: 17/776,467

(22) PCT Filed: Nov. 15, 2020
(86) PCT No.: PCT/IL2020/051180

§ 371 Date: May 12, 2022

(30) Foreign Application Priority Data
Nov. 14, 2019 (IL) 270660
Nov. 21, 2019 (IL) 270839
Dec. 4, 2019 (IL) 271176

(51) Int. Cl. C04B 28/04; E04C 2/288; C04B 24/26; C04B 14/06; C04B 14/28

(52) U.S. Cl. CPC C04B 28/04; E04C 2/288; C04B 24/2676; C04B 14/06; C04B 14/28; C04B 2111/00612

(57) ABSTRACT

A continuous flexible cement sheet roll for coating construction slabs, is disclosed. The sheet comprising a flexible cement layer, which has a thickness of between 0.3 to 6 mm, such as between 0.5 and 5 mm, and which comprises a) essentially inorganic mortar and b) up to 15% polymeric binder. When the amount of a component in a mixture is expressed in % units, the weight % of the component relative to the weight of the whole mixture is intended. The flexible cement sheet roll of the invention comprises, a reinforcing layer of a thickness lower than the thickness of said cement layer, selected from films of a nonwoven fabrics, layers of organic or inorganic fibers, polymer webs, chop strand mat, and fiberglass mats, among others.

### TECHNICAL FIELD OF THE INVENTION

This invention is generally related to cement sheets for building construction and more particularly to flexible sheet of cementitious material for coating construction panels, a readymade thin sheet of intumescent material for coating construction elements and to a cost-effective method of manufacturing continuous thermo-insulating layers for coating construction building elements.

### BACKGROUND OF THE INVENTION

Composite panels comprising expanded or extruded polystyrene (PS) cores and cementitious coatings have become an integral part of modern building construction. Since more than 90% volume of the PS may be air, PS slabs can act as a highly efficient thermal insulator. The coated panels make superior insulation against thermal and vibration impacts. The lightweight panels also make the whole structure seismically safer. The coated panels are resistant to moisture and to microbial attacks, and are used for both interior and exterior purposes, being employed in walls, floors, ceilings, roofs, and foundations. The coating strengthens the core and may serve as a base for additional surface changes, including ceramic tiles, plaster, and others. Other polymers are used in construction, including polyurethane (PU).

However, conventional processes for producing cementitious panels are quite complex, demanding too much working space and too complex manufacturing equipment, the resulting products being costly and not sufficiently competitive with less environmental friendly construction elements. The number of problems include, for example, premature or delayed setting of the slurry on the coated slab, difficulties in feeding the slurry upon a moving substrate, difficulties about the maintenance of cement delivering equipment and about clogging, and uneven deposition of the slurry on the slabs. It is therefore an object of the invention to provide a simpler process for obtaining coated polystyrene or other slabs.

It is another object of this invention to provide a cost-effective process requiring less production space and equipment than known processes for manufacturing coated slabs or sandwich slabs, including panels comprising PS, PU, fiberglass, mineral or glass fibers, the panel being coated with cement-like thin layers.

Other objects and advantages of present invention will appear as the description proceeds.

Human fire deaths in the world are estimated at 120,000 per year. In the U.S. alone, fire departments annually respond to about 350,000 home structure fires per year, causing about 11,000 injuries and about $7 billion in direct property damages. The increased use of polymeric panels in the house construction poses new challenges in the protection against fire spreading.

Flame-retardant additives (FRs), mostly brominated organics, are broadly admixed into polymers and other materials intended for interior use. FRs inhibit fire ignition and spread of fire, but their long and wide use resulted in huge environmental contamination, which is now suspected to affect immune, neurologic, and reproductive functions in animals and humans. Another way to slow down the fire spread is creating a thin layer of intumescent material on the surface of the protected object; the thin intumescent substance layer swells when exposed to heat and forms a thick inflammable layer of low density, becoming an obstacle to heat transfer, as the rate of heat transfer decreases with the material density and as it is indirectly proportional to the thickness of the obstacle. Compared to FRs, the intumescent chemistry does not pose the mentioned health hazards, and it requires lower material quantities, as it is applied only on the surface and not inside the protected volumes. Moreover, the intumescent layer may be employed also on hard metal surfaces, including steel construction elements. Steel loses strength at temperatures above 300° C., so that it may be critical to slow the heat transfer toward the steel columns and beams during a fire event, to prevent a building collapse or to provide for more time to people to escape and to the firemen to handle the fire before the eventual building collapse. This is another important field for the application of intumescent coatings, which may withstand temperatures of up to 600° C. or even 1200° C.

Industrial intumescent coatings for fire-protecting exterior and interior construction elements are usually applied as liquid substrates, such as paints or sprays, demanding tenacious efforts when covering the whole surface of the objects in the required environment, including vertical surfaces and down-facing horizontal surfaces, which includes substantial work force and costs, also because of necessary protection of the personnel from the employed liquid substrates, notwithstanding the dangers for the personnel resulting from their long stay in dangerous places, positions, heights, etc. Moreover, the intumescent layer so created in situ often shows imperfections, non-uniform thickness or smoothness, which has both technical and aesthetical consequences. Sometimes, the coating layer may sag or otherwise move due to gravitation flow or excessive thickness. To prevent problems on the underside of construction members, multiple thinner coats must be applied, which still more increases the costs. It is therefore an object of the invention to provide an intumescent layer for construction elements without the drawbacks of the known methods. It is another object of this invention to provide a cost-effective process for protecting construction elements, including panels, walls, ceilings, beams, and columns with intumescent layers.

It is further an object of the invention to provide an intumescent layer for technically simple and cost-effective protection of construction elements.

It is also an object of the invention to provide a universal fire-retarding system for construction elements, which is, in addition, environmentally friendly and safe for human health both in time of production and in time of use.

Other objects and advantages of present invention will appear as the description proceeds.

Enhancing efficiency in the energy utilization is one of the primary goals of today's technologic development. Reducing energy losses on heating and cooling the buildings would contribute immensely to said efficiency. The reduction in heat transfer between the interior and exterior of the buildings is achieved by advanced construction engineering techniques, but also by modifying the heat transfer properties of the existing building surfaces. One of the broadly used techniques is painting the surfaces such as roofs with a thermal protecting paint.

Thermal protecting paints are usually applied as liquid substrates via spraying of spreading with brush, which demands laborious procedures when covering large surfaces of the objects, particularly when including vertical surfaces and down-facing horizontal surfaces. Such procedures include substantial work force and costs, also because of necessary protection of the personnel from the employed liquid substrates, notwithstanding the dangers for the personnel resulting from their long stay in dangerous places, positions, heights, etc. Moreover, the insulating paint layer so created in situ often shows imperfections, non-uniform thickness or smoothness, which has both technical and aesthetical consequences. Sometimes, the coating layer may sag or otherwise move due to gravitation flow or excessive thickness. To prevent problems on the underside of construction members, multiple thinner coats must be applied, which still more increases the costs. Repeated painting steps are required also for ensuring sufficient effects, as one paint layer usually provides too weak protection. It is therefore an object of the invention to provide a method for reducing the heat transfer through the building surfaces without the drawbacks of the known methods.

It is another object of this invention to provide a cost-effective process for protecting construction elements, including panels, walls, ceilings, beams, and columns with a thermo-insulating layer.

It is further an object of the invention to provide a thermo-insulating layer for technically simple and cost-effective protection of construction elements.

It is also an object of the invention to provide a universal thermo-insulating system for construction elements, which is, in addition, environmentally friendly and safe for human health both in time of production and in time of use.

Other objects and advantages of present invention will appear as the description proceeds.

### SUMMARY OF THE INVENTION

Aspects of the invention provides a continuous flexible cement sheet roll for coating construction slabs, the sheet comprising a flexible cement layer, which has a thickness of between 0.3 to 6 mm, such as between 0.5 and 5 mm, and which comprises a) essentially inorganic mortar and b) up to 15% polymeric binder. When the amount of a component in a mixture is expressed in % units, the weight % of the component relative to the weight of the whole mixture is intended. The flexible cement sheet roll of the invention comprises, in one embodiment, a reinforcing layer of a thickness lower than the thickness of said cement layer, selected from films of a nonwoven fabrics, layers of organic or inorganic fibers, polymer webs, chop strand mat, and fiberglass mats, among others. In one embodiment, the flexible cement sheet roll of the invention comprises a polymeric foil which lines said cement layer; the foil is attached on one of the sheet surfaces.

In some embodiments, the flexible cement sheet comprises said reinforcing layer, usually embedded within the cement layer, in other embodiments the cement sheet comprises said attached foil, and in other embodiments the cement sheet comprises both. Said flexible cement sheet of the invention preferably comprises hydraulic cement; sand; water; polymeric binder; and up to 10% additives selected from thickeners, fillers, plasticizers, surfactants, dispersants, antifoams, rheology affecting agents, hydrophobicity adjusting agents, and flame retardants (FRs). Said cement layer in the flexible cement sheet roll of the invention usually comprises i) 70% hydraulic cement; ii) 10-25% sand; iii) up to 10% chalk or calcium carbonate; iv) 5-15% water; v) 5-15% polymeric binder; and vi) up to 5% additives selected from thickeners, fillers, plasticizers, surfactants, dispersants, antifoams, rheology affecting agents, hydrophobicity adjusting agents, and flame retardants (FRs).

In a preferred embodiment of the flexible cement sheet roll, said cement layer comprises i) 50-60% hydraulic cement of Portland types; ii) 13-23% quartz sand; iii) 5-9% chalk or calcium carbonate; iv) 8-12% water; v) 5-9% polymeric binder comprising agents selected from acrylates, styrene acrylic copolymers, styrene and butadiene copolymers, epoxy resins, methyl methacrylate, unsaturated polyester resins, polyurethane, and vinyl esters; and vi) 0.5-5% additives selected from thickeners, fillers, plasticizers, surfactants, dispersants, wetting agents, antifoams, rheology affecting agents, hydrophobicity adjusting agents, flame retardants (FRs), preservatives, and dyes.

In some embodiments of the invention, the flexible cement sheet roll comprises a reinforcing layer comprising fiberglass embedded in said cement layer. In other embodiments of the invention, the flexible cement sheet roll comprises a polymeric foil which lines said cement layer, the foil comprising a polymer fabric or textile, preferably nonwoven fabric, such as for example comprising polyester or polyester terephthalate.

The invention relates to a flexible cement sheet roll as above described, for coating construction elements including foamed or extruded polymeric slabs, polystyrene or polyurethane panels, carton slabs, or slabs comprising mineral or organic fibers, but also for coating the surfaces of other construction elements including beams and columns, comprising various construction materials including steel, said sheet comprising a cement layer of a uniform thickness of between 1 and 4 mm, optionally a reinforcing layer embedded in said cement layer, and optionally a polymeric foil lining said cement layer, wherein said roll may have a width of 0.2-2 m, and said sheet may have a length of 50-300 m.

The invention provides a process for manufacturing a continuous flexible cement sheet for coating construction elements, comprising i) preparing a cement mortar mixture by homogenizing hydraulic cement, sand, water, 5-15% polymeric binder added to the mixture as a fine dispersion, and up to 10% additives comprising agents selected from plasticizers, superplasticizers, antifoams, thickeners, fillers, dispersants, and viscosity adjusting agents; ii) layering said cement mortar mixture onto a heat-resistant surface of a conveyor, the surface optionally covered by a polymeric foil, thereby forming a wet cement mortar layer of a thickness of from 0.5 to 5 mm; iii) optionally embedding in said wet cement mortar layer a reinforcing layer of a thickness lower than the thickness of said wet cement mortar layer, selected from a film of a nonwoven fabric, a layer of organic or inorganic fibers, a polymer web, chop strand mat, and fiberglass mat; iv) moving said heat resistant surface, optionally with said polymeric foil, bearing said wet cement mortar mixture, optionally with said reinforcing layer, through an oven set at 110-140° C. in which said wet cement mixture sets, thereby forming a flexible solid layer; v) peeling said flexible solid layer from said heat resistant surface, optionally with said polymeric foil being attached to said flexible solid layer and lining said flexible solid layer, thereby obtaining said continuous flexible cement sheet; vi) rolling said flexible cement sheet up, thereby obtaining a roll of readymade continuous separate cement sheet for immediate or future use in coating construction elements; the continuous sheet being enough strong and flexible to be unfolded and glued on the surface of said construction elements, including foamed or extruded slabs, polystyrene or polyurethane panels, carton slabs, slabs comprising mineral or organic fibers, and metal columns or beams.

The process of the invention preferably comprises i) preparing said homogeneous cement mortar mixture by mixing 35-60% hydraulic cement, 8-20% quartz sand, up to 8% of chalk or calcium carbonate, 15-30% water, 5-15% polymeric binder added to the mixture as a concentrated fine dispersion, and up to 4% additives comprising agents selected from plasticizers, superplasticizers, antifoams, thickeners, fillers, dispersants, surfactants, dispersants, rheology affecting agents, hydrophobicity adjusting agents, FRs, dioctylphthalate, aluminum hydroxide, magnesium hydroxide, cellulose, nylon, fume silica, perlite, vermiculite, glass, PP, basalt, and other suitable components compatible with the described mixture; ii) layering said cement mortar mixture onto said heat-resistant surface, the surface comprising a Teflon© surface of a belt conveyor 0.2-2 m wide, optionally covered with said polymeric foil; iii) optionally embedding said reinforcing layer in said wet cement mortar layer, the reinforcing layer comprising fiberglass; iv) moving said heat resistant surface bearing said wet cement mixture optionally with said reinforcing layer into an oven set at 120-130° C., in which said wet cement mortar mixture sets to form said flexible solid layer; v) peeling said layer from said foil, optionally together with said polymeric foil which becomes an integral part of the produced flexible sheet, thereby obtaining said continuous flexible cement sheet, optionally lined with the foil; vi) rolling said flexible sheet up, thereby obtaining a roll of continuous cement sheet having a length of 20-200 m for immediate use or for storing for a future use; the continuous sheet being enough strong and flexible to be unfolded and glued onto the surface of said construction elements, including foamed and extruded slabs, polystyrene or polyurethane panels, carton slabs, slabs comprising mineral or organic fibers, and metal columns or beams.

The process for manufacturing a continuous flexible cement sheet for coating construction elements according to the invention, the sheet most preferably being folded and rolled up in compact rolls, easy for manipulation and transport, is performed in a continuous manner or in a batch manner. Said polymeric foil which lines the flexible cement layer is preferably selected form nonwoven fabric webs.

In one aspect, the invention relates to a process for manufacturing a building composite panel comprising a polymer slab core and a cement coat attached at least on one side of the slab, comprising i) preparing a cement mortar mixture by homogenizing hydraulic cement, sand, water, 5-15% polymeric binder added to the mixture as a fine dispersion, and up to 10% additives comprising agents selected from plasticizers, superplasticizers, antifoams, thickeners, fillers, dispersants, and viscosity adjusting agents; ii) casting said cement mortar mixture onto a heat-resistant surface of a conveyor, the surface optionally covered by a polymeric foil, thereby forming a wet cement mortar layer of a thickness of from 0.5 to 5 mm; iii) optionally embedding in said wet cement mortar layer a reinforcing layer of a thickness lower than the thickness of said wet cement mortar layer, the reinforcing layer being selected from a film of a nonwoven fabric, a layer of organic or inorganic fibers, a polymer web, an alkali resistant mat, chop strand mat, and fiberglass mat; iv) setting cement mortar layer by exposing it to a temperature of 110-140° C., in a continuous or in a batch manner, thereby providing a solid and flexible cement layer; v) peeling said flexible cement layer, optionally with said polymeric foil attached to said flexible cement layer, thereby obtaining a continuous flexible cement sheet; vi) folding the sheet to provide a roll of a separate readymade flexible cement sheet; vii) applying glue on one side of said slab core or on one side of said flexible cement sheet after unfolding the flexible cement sheet from the coil, and pressing said cement sheet onto said core, thereby obtaining a composite panel coated on one side; viii) optionally gluing said flexible cement sheet on the second side of said slab, thereby obtaining a sandwich building composite panel; and ix) clearing and cutting the coated slab to desired size; thereby obtaining building structure elements coated on one or two sides, including sandwich-structured polystyrene panels coated on both sides.

Said additives in the preparation of the mortar cement mixture may be added up to usually up to 5%, for example up to 4%, such as up to 3%. Usually, one additive is added to up to 1%, such as up to 0.4%, or up to 0.3% or up to 0.2%, or between 0.1% and 1.0%.

Said polymeric binder is preferably added to the wet mortar cement mixture in the form of a latex, namely a fine dispersion in a suitable solvent, often water. In describing the working mixtures, such as wet mortar cement mixture, total water amount is given, including free added water and water comprised in the added dispersions. The binder dispersion, even when related to as a polymeric binder, may comprise polymers, oligomers, or monomers in some stages of the process, in various combinations, and the final polymeric state may be achieved only after admixing the binder dispersion or latex, and after heating the mortar cement mixture in said oven.

The polymer, oligomer, and monomer components may comprise known chemistries and chemical species, including acrylates, styrenes, urethanes, epoxies, styrene-butadiene, and combinations thereof. The dispersions usually contain 40-60% solids.

An important aspect of the invention is manufacturing of coated construction elements, including columns, beams, walls, and importantly building panels coated with cement layer, for which the invention provides easy-to manipulate, readymade rolls of separate cement layer, which is flexible and can be easily unfolded to be glued onto any construction surface, particularly on the surfaces of foamed and extruded polymer slabs.

The rolls may have any suitable dimensions; the width of the unfolded sheet being for example 0.25 m or more, such as 0.5 m, 0.75 m, 1 m, 1.25 m, 1.5 m, 1.75 m, or 2 m or more. The length of the continuous flexible sheet on the roll may be for example 50 m or more, such as 100 m, or 150 m, or 200 m, or 250 m, or 300 m, or more than 300 m. The folded roll, essentially having cylindrical shape, may have said cylinder's diameter of about 0.25 m, or about 0.5 m or about 0.75 m, or about 1 m, or more than 1 m. A flexible sheet of a thickness of 5 mm will roll up to a cylinder of more than 1 m in diameter if the sheet should have a length of above 150 m, whereas a thinner flexible sheet of 1 mm thickness will roll up to a cylinder of below 0.5 m in diameter if the sheet should have a length of more than 150 m.

The flexible sheet roll of the invention can be immediately used, or stored after packaging and used later, cost effectively and in a technically simple manner. The stable and flexible readymade, separate cement layer sheet is enough robust and stable to be easily unfolded and glued onto a surface of any construction element which requires creating a cement surface, while obviating obstacles and drawbacks of available procedures, and while precluding complex activities usually associated with unwieldy mortar/cement preparation and application steps.

Other aspects of the invention provides an intumescent sheet for coating building construction elements, the sheet comprising a layer of an intumescent mixture having a thickness of between 0.5 and 5 mm and a reinforcing flexible mat. The intumescent sheet of the invention may comprise several reinforcing layers in the form of foils, films, mats or webs of a thickness lower than the thickness of the intumescent mixture, selected from a layer of organic or inorganic fibers, a polymer web, chopped strand mat, fiberglass mat, roving, carbon fibers, a film of a nonwoven fabric, or a thin polymer film. Said flexible mat preferably comprises a layer of organic or inorganic fibers, a polymer web, chopped strand mat, fiberglass mat, roving, carbon fibers, or nonwoven fabric. Said intumescent mixture in the sheet of the invention preferably comprises ammonium polyphosphate, a polyol, a spumific agent, and additives. Said additives may comprise one or more components selected from polymeric emulsions, latexes, flexibility enhancers, plasticizers, synergists, dispersants, antifoams, surfactants, preservatives such as for example fungicides, biocides, and insecticides, fillers, or dyes. The intumescent sheet of the invention comprises in one embodiment a reinforcing mat that is embedded in said layer of the intumescent mixture or lines said mixture, for example a material comprising fiberglass.

The intumescent sheet of the invention for coating construction elements and protecting them from fire, elements selected from foamed or extruded polymeric slabs, carton slabs, gypsum panels, plaster boards, slabs comprising mineral or organic fibers, polystyrene or polyurethane panels, prefab walls, ceilings, steel beams, and steel columns, comprises said intumescent layer of a uniform thickness of between 0.5 and 5 mm, optionally said reinforcing mat attached to or embedded within the intumescent layer, wherein said sheet is flexible and foldable to be rolled up to a roll. The intumescent sheet is in a preferred embodiment of the invention a continuous flexible sheet rolled up to a roll stable on storage and usable anytime and anywhere for coating and fire-protecting structure building elements. The intumescent sheet of the invention may be a continuous sheet having a width of, for example, 0.1 to more than 3 m, such as 0.3-3 m, and a length of, for example, 20-400 m, such as 30-300 m. However, the system of the invention provides any desired dimensions. The intumescent sheet of the invention is configured to be used for coating of the surfaces of building construction elements. In one embodiment, said coating comprises applying glue on said sheet or on said surfaces and gluing said sheet on said surfaces. In other embodiments, the sheet is attached onto said surfaces at specific points or areas or lines or stripes, either by applying glue or by mechanical means, or by adhesive band or tape or glue, or by anchoring said sheet to said surfaces by mechanical means, or by any known attachment means. The intumescent sheet of the invention, for coating the surfaces of building construction elements, comprises in a preferred embodiment an outer adhesive film as an integral part of the intumescent sheet, said layer serving for attaching said sheet to said protected surface. In another embodiment, the intumescent sheet of the invention, for coating the surfaces of building construction elements, comprises an adhesive layer for gluing said sheet on said surface and further a protective non-adhesive film attached on the outer side of said adhesive layer, the film being removed before the gluing step.

The invention relates to a process for manufacturing an intumescent sheet for coating construction building elements, comprising i) preparing a wet intumescent mixture by homogenizing ammonium polyphosphate, a polyol, a spumific agent, and one or more additives selected from solvents, polymeric emulsions or dispersions, viscosity adjusters, dispersants, antifoams, surfactants, fillers, flexibility enhancers, plasticizers, synergists, preservatives, and dyes; ii) layering said mixture onto a heat-resistant reinforcing mat comprising a layer of organic or inorganic fibers, a polymer web, chopped strand mat, fiberglass mat, roving, carbon fibers, or nonwoven fabric to form a layer of a thickness of 0.2 to 8 mm, such as 0.5 to 5 mm; and iv) placing said wet layer through in an oven set at a temperature higher than ambient, for example between 70 and 120° C., and drying said layer, either batchwise or continuously; thereby obtaining said intumescent sheet as a readymade intumescent sheet to be immediately used or stored for future use. In a preferred embodiment of the process according to the invention, said sheet is a continuous flexible sheet, and the process further comprises a step of folding and rolling up said continuous flexible sheet to rolls for storage and future use. The process preferably comprises i) preparing said homogeneous mixture by mixing 45-65 wt % intumescent components consisting of ammonium polyphosphate, pentaerythritol and melamine in a weight ratio of about 2:1:1, 15-30 wt % emulsion of a polymeric binder, 5-15 wt % water, and 15-25 wt % other additives; ii) layering said mixture onto said reinforcing mat, such fiberglass placed on a belt conveyor 0.2-2 m wide; iii) optionally embedding another reinforcing web in said wet layer; iv) optionally attaching to said separate intumescent sheet an adhesive liner, optionally protected on the outer side by a non-adhesive film; v) moving said layer into an oven set at a temperature of 70-120° C., thereby drying said layer and obtaining continuous flexible intumescent sheet; vi) rolling said flexible sheet up, thereby obtaining a roll of readymade continuous separate intumescent sheet having a desired length, for example of up to 500 m, such as 20-300 m, for immediate use or for storing for a future use; the continuous sheet being enough strong and flexible to be unfolded and attached onto the surface of said construction elements, including foamed and extruded slabs, polystyrene or polyurethane panels, carton slabs, gypsum panels, plaster boards, slabs comprising mineral or organic fibers, and metal columns or beams. The process of the invention further may comprise a step of attaching to said separate intumescent sheet an adhesive liner protected on the outer side by a non-adhesive film, for example a paper film. The whole process may be performed in a continuous manner or in a batch manner.

The invention provides a system and a process for fire-protecting construction building elements selected from slabs comprising mineral or organic fibers, foamed and extruded slabs, polystyrene or polyurethane panels, carton slabs, gypsum panels, plaster boards, metal columns or beams, composite panels comprising polymer cores and cement coats, interior ceilings, and interior walls, comprising steps of i) preparing a wet intumescent mixture by homogenizing ammonium polyphosphate, a polyol, a spumific agent, and one or more additives selected from polymeric dispersions or emulsions,

water, other solvents, viscosity adjusters, dispersants, antifoams, surfactants, fillers, preservatives, flexibility enhancers, plasticizers, synergists, and dyes; ii) layering said mixture onto a heat-resistant reinforcing mat comprising a layer of organic or inorganic fibers, a polymer web, chopped strand mat, fiberglass mat, roving, carbon fibers, or nonwoven fabric to form a layer of a thickness of about 0.5 to 5 mm; iii) optionally embedding in said wet layer another reinforcing mat or web; iv) moving said wet layer through an oven set at a temperature of 70-120° C. and drying said layer, thereby obtaining a readymade intumescent sheet; v) optionally rolling up said separate sheet, which is foldable and flexible, to rolls of continuous readymade intumescent sheet having a width of, for example, 0.3-3 m, and a length of, for example, 30-300 m; and vii) attaching said sheet onto the surface of said building elements either via glue or mechanical means or an adhesive layer, said glue being applied either on said sheet or on said surface, either on the whole surface or on restricted areas or lines or stripes or points; said intumescent layers being converted during a fire event to solid noncombustible insulating foam covering said surface of the construction elements, thereby substantially reducing heat transfer through said surface.

Additional aspects of the invention provides a thermoinsulating sheet for coating building construction elements, the sheet comprising a layer of a thermoinsulating mixture having a thickness of between 0.2 and 4 mm and a reinforcing flexible mat. The thermoinsulating sheet of the invention may comprise several reinforcing layers in the form of foils, films, mats or webs of a thickness lower than the thickness of the thermoinsulating mixture, selected from a layer of organic or inorganic fibers, a polymer web, chopped strand mat, fiberglass mat, roving, carbon fibers, a film of a nonwoven fabric, or a thin polymer film. Said flexible mat preferably comprises a layer of organic or inorganic fibers, a polymer web, chopped strand mat, fiberglass mat, roving, carbon fibers, or nonwoven fabric. Said thermoinsulating mixture in the sheet of the invention preferably comprises components selected from dried polymeric emulsions, metal oxides, flexibility enhancers, plasticizers, dispersants, surfactants, and fillers. Said components may comprise one or more components selected from polymeric emulsions, latexes, commercial thermal paint, flexibility enhancers, plasticizers, synergists, dispersants, antifoams, surfactants, preservatives such as for example fungicides, biocides, and insecticides, fillers, or dyes. The thermo-insulating sheet of the invention comprises in one embodiment a reinforcing mat that is embedded in said layer of the thermo-insulating mixture or lines said mixture, for example a material comprising fiberglass.

The thermo-insulating sheet of the invention for coating construction elements and thermally protecting them, elements selected from walls, roofs, ceilings, polymeric slabs, slabs comprising mineral or organic fibers, polystyrene or polyurethane panels, carton slabs, gypsum panels, plaster boards, cement boards, prefab walls, steel beams, and steel columns, comprises said thermo-insulating layer of a uniform thickness of between 0.2 and 4 mm, optionally said reinforcing mat attached to or embedded within the thermo-insulating layer, wherein said sheet is flexible and foldable to be rolled up to a roll. The thermo-insulating sheet is in a preferred embodiment of the invention a continuous flexible sheet rolled up to a roll stable on storage and usable anytime and anywhere for coating and thermally protecting structure building elements. The thermo-insulating sheet of the invention may be a continuous sheet having a width of, for example, 0.1 to more than 3 m, such as 0.3-3 m, and a length of, for example, 20-400 m, such as 30-300 m. However, the system of the invention provides any desired dimensions. The thermo-insulating sheet of the invention is configured to be used for coating of the surfaces of building construction elements. In one embodiment, said coating comprises applying glue on said sheet or on said surfaces and gluing said sheet on said surfaces. In other embodiments, the sheet is attached onto said surfaces at specific points or areas or lines or stripes, either by applying glue or by mechanical means, or by adhesive band or tape or glue, or by anchoring said sheet to said surfaces by mechanical means, or by any known attachment means. The thermo-insulating sheet of the invention, for coating the surfaces of building construction elements, comprises in a preferred embodiment an outer adhesive film as an integral part of the thermo-insulating sheet, said layer serving for attaching said sheet to said protected surface. In another embodiment, the thermo-insulating sheet of the invention, for coating the surfaces of building construction elements, comprises an adhesive layer for gluing said sheet on said surface and further a protective non-adhesive film attached on the outer side of said adhesive layer, the film being removed before the gluing step.

The invention relates to a process for manufacturing a thermo-insulating sheet for coating construction building elements, comprising i) preparing a wet thermo-insulating mixture by homogenizing components selected from polymeric emulsions, solvents, metal oxides, flexibility enhancers, plasticizers, dispersants, surfactants, and fillers; ii) layering said mixture onto a heat-resistant reinforcing mat comprising a layer of organic or inorganic fibers, a polymer web, chopped strand mat, fiberglass mat, roving, carbon fibers, or nonwoven fabric to form a layer of a thickness of 0.2 to 4 mm; and iii) placing said wet layer through in an oven set at a temperature higher than ambient, for example between 70 and 130° C., and drying said layer, either batchwise or continuously; thereby obtaining said thermo-insulating sheet as a readymade thermo-insulating sheet to be immediately used or stored for future use. In a preferred embodiment of the process according to the invention, said sheet is a continuous flexible sheet, and the process further comprises a step of folding and rolling up said continuous flexible sheet to rolls for storage and future use. The process preferably comprises i) preparing said homogeneous mixture by mixing a polymeric emulsion or commercial thermal protective paint, solvents, metal oxides, flexibility enhancers, plasticizers, dispersants, and surfactants; ii) layering said mixture onto said reinforcing mat, such fiberglass placed on a belt conveyor 0.2-2 m wide; iii) optionally embedding another reinforcing web in said wet layer; iv) optionally attaching to said separate thermo-insulating sheet an adhesive liner, optionally protected on the outer side by a non-adhesive film; v) moving said layer into an oven set at a temperature of 70-130° C., thereby drying said layer and obtaining continuous flexible thermo-insulating sheet; vi) rolling said flexible sheet up, thereby obtaining a roll of readymade continuous separate thermo-insulating sheet having a desired length, for example of up to 500 m, such as 20-300 m, for immediate use or for storing for a future use; the continuous sheet being enough strong and flexible to be unfolded and attached onto the surface of said construction elements, including walls, roofs, prefab panels, foamed and extruded slabs, slabs comprising mineral or organic fibers, polystyrene or polyurethane panels, carton slabs, gypsum panels, plaster boards, and metal columns or beams. The process of the invention further may comprise a step of attaching to said separate thermo-insulating sheet an adhesive liner protected on the outer side by a non-adhesive film, for example a paper film. The whole process may be performed in a continuous manner or in a batch manner.

The invention provides a system and a process for thermally protecting construction building elements selected from walls, roofs, ceilings, columns, beams, foamed and extruded slabs, carton slabs, gypsum panels, plaster boards, slabs comprising mineral or organic fibers, polystyrene or polyurethane panels, metal composite panels comprising polymer cores and cement coats, comprising steps of i) preparing a wet thermo-insulating mixture by homogenizing a polymeric emulsion or commercial thermal protective paint, solvents, metal oxides, flexibility enhancers, plasticizers, dispersants, surfactants, viscosity adjusters, antifoams, fillers, preservatives, and dyes;

ii) layering said mixture onto a heat-resistant reinforcing mat comprising a layer of organic or inorganic fibers, a polymer web, chopped strand mat, fiberglass mat, roving, carbon fibers, or nonwoven fabric to form a layer of a thickness of about 0.2 to 4 mm; iii) optionally embedding in said wet layer another reinforcing mat or web; iv) moving said wet layer through an oven set at a temperature of 70-130° C. and drying said layer, thereby obtaining a readymade thermo-insulating sheet; v) optionally rolling up said separate sheet, which is foldable and flexible, to rolls of continuous readymade thermo-insulating sheet having a width of, for example, 0.3-3 m, and a length of, for example, 30-300 m; and vii) attaching said sheet onto the surface of said building elements either via glue or mechanical means or an adhesive layer, said glue being applied either on said sheet or on said surface, either on the whole surface or on restricted areas or lines or stripes or points; said thermo-insulating layer reducing the heat transfer through said surfaces and reflecting heat radiation.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It has now been found that the cement-coated polystyrene (PS) slabs can be manufactured in a simple and environmental friendly process, doing with less working space and less complex manufacturing equipment than the known processes, while providing cost-effective products of any desired dimensions. The process of the invention precludes the problems with moving the panel to be coated to the sites of the coating activities, problems with premature or delayed setting of the formed cement slurry, problems with uneven deposition of the slurry on the slabs, and difficulties about the maintenance of cement delivering equipment and about clogging.

The invention preferably provides PS panels coated with a cement layer, either made of expanded polystyrene (EPS) or extruded polystyrene (XPS), either coated on one side or on two sides. The continual flexible cement sheet may be advantageously employed for coating other polymer slabs and even other building elements. The method of the invention avoids cumbersome steps of existing methods, such as transporting PS or other slabs through coating machines whereby forming a cement layer on one side of the slab, embedding fiberglass within said layer on the slab, sawing the slab with a layer in desired pieces, and repeating the coating on the other side of the slab. The method of the invention provides a cement layer entirely separate from the slab and combines the separate cement layer with the slab when the layer is not wet any more. Moreover, the separate cement layer is flexible and well workable, so that it can be rolled up to provide rolls of a separate readymade cement layer to be glued onto PS slabs anytime and anywhere needed.

The separate cement layer sheet according to the invention is prepared from a mixture comprising 15-70% cement, 5-30% polymerizable or polymerized latex dispersion, 5-25% sand, up to 10% chalk or lime or calcium carbonate, 10-35% water, and additives comprising agents selected from thickeners, fillers, plasticizers, surfactants, dispersants, antifoams, rheology affecting agents, wetting agents, hydrophobicity adjusting agents, flame retardants (FRs), and others. Percent values relate to weight percent throughout. In some embodiments, the latex emulsion comprises styrene-butadiene (SB). In some embodiments, the additives comprise plasticizers like dioctylphthalate. In some embodiments, the FR comprise aluminum hydroxide or magnesium hydroxide. In some embodiments, the fillers comprise polymers like cellulose or nylon. In some embodiments, the fillers comprise fume silica or perlite.

The wet mixture for producing the cement layer may comprise, in some embodiments, 30-70% cement, 5-20% latex dispersion, 5-25% quartz sand, 2-10% chalk or calcium carbonate, 5-30% water, 0.5-10% total additives; the amount of dry polymer binder in the mixture may be 2-15%, such as 3-10%; the total amount of water in the mixture may be 7-45%, such as 8-35%. In some embodiment, said mortar-like wet mixture for producing the flexible cement layer may comprise, 40-60% cement, 10-20% latex emulsion, 10-25% quartz sand, up to 10 chalk or calcium carbonate, 10-20% water, 0.5-1% superplasticizer, and antifoam, thickener, filler, dispersant, surfactant, viscosity adjusting agent, each one in an amount between 0.1 to 1.0%; the amount of dry polymer binder in the mixture may be 4-12%, such as 5-10%; the total amount of water in the mixture may be 15-35%, such as 20-30%. The wet mixture for producing the cement layer may for example comprise 40-60% cement, 10-16% latex dispersion, 10-22% quartz sand, 4-9% chalk, 5-25% water, and 0.8-4% total additives, while the amount of dry polymer binder may be 5-8%, and the total amount of water in the mixture may be 15-32.

Said viscosity adjusting agents may comprise rheological agents such as cellulose to bind water. Said latex dispersion may comprise polymer or polymerizable components. A part of the cement or sand in the wet mortar mixture may be replaced with calcium oxide or calcium hydroxide or plaster or calcium sulfate. Water reducing agents may be added, and surfactants to improve workability. If lighter sheet is desired, a component selected from perlite, vermiculite, fume silica, and hollow sand or other light filler may be added. When a flame retardant is desired, aluminum hydroxide or magnesium hydroxide may be added. Hydrophobic agents may be added. For increasing flexibility, dioctylphthalate (DOP) or similar agents may be added. In order to prevent cracks, fibers may be added, such as nylon, glass, PP, basalt, and others. Other additives or fillers compatible with the coating may be employed.

An advantageous aspect of the technology according to the invention is providing a cement layer separately, which facilitates the process and enables to produce thinner panels. Said cement layer, comprising components as described above, is layered, for example by spraying, onto a polymeric surface to bear it to an oven, the surface comprising for example a Teflon coating on a conveyor belt which is a part of the manufacturing equipment, comprising nonwoven textile, such as polyester foil, or PET, placed on the conveyor belt, possibly becoming an integral part of the final, dry, flexible cement layer. In one preferred embodiment, fiberglass is inserted in the wet cement layer, the layer moving to an oven heated to 120-130° C. The wet cement mixture undergoes setting when exposed to said high temperature, providing a solid and firm but flexible cement sheet, which is then peeled from the polymer foil and rolled up on a reel. The peeling step may be combined with the coating step in a continuous process; in a preferred embodiment, the peeled flexible cement sheet is rolled up for storage, marketing, and transport. The desired product is preferably a reel or roll of a flexible cement layer for use in coating foamed polymer core, either on one side or on both side of the core slab. In some embodiments, the sheet is wound on a reel core; in other embodiments, the wound sheet is densely rolled up for storage and transport without any core. Preferably, the slab comprises PS slabs, and the process of the invention provides composite building panels comprising either PS coated with said flexible cement sheet on one side, or sandwich panels comprising PS slab coated on both sides.

One of the advantageous features of the invention is providing a separate flexible cement sheet, readymade for future use in coating foamed slabs to provide building panels. In a preferred embodiment, the flexible cement sheet prepared for coating slabs, such as foamed polymer slabs like PS or PU slabs, is rolled up on rolls stable and ready for any future use, the flexible cement sheet usually having a thickness of 0.3-6 mm, preferably 0.5-5 mm, such as 1-4 mm, for example 2-3 mm, and being rolled as sheets for example 20-200 cm wide, and 50-300 m long, the rolls having the form of cylinders of a diameter usually between 0.2 and 1 m.

The invention provides a process for manufacturing composite panels comprising foamed slabs coated with a cement layer, comprising a step of gluing the readymade cement sheet of the invention as above described onto foamed polymer slabs. The slabs are combined with the cement sheet on one or both sides while employing glue between the foamed polymer and the cement sheet. The invention provides composite building panels, preferably in a continuous process comprising steps of spreading glue on the surface of the foamed slab or flexible cement sheet, combining the slab and the sheet, and cutting the composite panels to the desired size and packaging.

A cement layer for coating construction slabs, such as polystyrene panels, readymade and separately pre-prepared for future use, for example as a 1-4 mm thick sheet of flexible cement layer reeled on a roll, for example 1 mm×30 cm×150 m; the layer may be cast, eventually comprising a fiberglass net, on a Teflon© conveyor belt, optionally covered with a polyester foil or glass fiber mat or other nonwoven web, to become an integral part of the peeled and rolled up flexible layer, to be placed in an oven at 120-130° C., and then peeled from the plastic base and rolled.

In one embodiment, the process for manufacturing the flexible sheet of the invention comprises coating said cement composition onto a thin polymer film, such as a textile layer, such as polyester, or onto a conveyor surface which is a part of the manufacturing device preferably comprising a Teflon layer, optionally covered with a nonwoven textile. The polymer surface bears the wet cement layer after its forming to an oven, the layer usually being from 0.5 to 5 mm high; a fiberglass comprising foil or mat or web is preferably sunk into the wet cement layer. The wet layer on said polymer surface which is heat resistant moves to the oven set at 120-130□ C., and after solidifying, the essentially dry flexible cement sheet is peeled off the underlying conveyor surface and is rolled up in the end of the production line. In one embodiment, the peeling step is performed in a peeling device. The cement layer may be layered onto a nonwoven textile or a fiber carpet which becomes an integral part of the produced cement sheet. Provided is a flexible cement sheet, optionally with a fiberglass-comprising film inside, the sheet being rolled up. The wet cement may be layered onto a foil which will become an integral part of the sheet, providing a flexible cement sheet with or without fiberglass inside, covered on the bottom with a nonwoven fabric, for example chop strand mat.

The process of manufacturing composite building panels according to the invention comprises i) providing rolls of a firm flexible cement sheet, for example 0.5-5 mm thick, for example 50-100 cm wide, and 100-200 m long, ii) gluing either one side of the sheet or one side of a building slab, iii) combining said sheet and said slab with the glue joining them to provide a composite panel for building; iv) cutting the composite panel to desired size; and v) optionally combining the second side of the slab with the sheet by said glue. In one embodiment, said glue is spread onto the surface of the cement flexible sheet and a panel is put onto it. If both panel sides are to be coated, its other side is covered with the glue and the flexible cement sheet is put onto it. The panel such as PS panel may move over the flexible cement sheet unfolded from a roll and covered with glue, the panel is pushed by its bottom side onto the glued surface of the flexible sheet, and one-side coated panel continues to move while being covered with glue on its upper side, while flexible sheet form another unfolding roll is pushed onto the panel upper side, followed by cutting and smoothening the edges of the sandwich panel by cutting means like saws or knives and by smoothening means, after which the sandwich panel is divide into parts of desired sizes, while removing residues and packaging the final composite building panels.

The invention thus provides a special product, process, and system comprising a roll of flexible cement sheet which is formed by a) casting inorganic mortar mixed with polymeric latex onto a heat resistant solid surface optionally covered with a polymeric foil, b) setting the cement, c) peeling the solidified cement, optionally with the foil, from said solid surface, and rolling it up for later use, which comprises d) unfolding and gluing said separate readymade rolled sheet onto construction slabs such as PS panels.

This invention relates to a process for producing composite building panels comprising cement-coated slabs, wherein a slurry of mortar and polymeric latex is cast on a solid surface, optionally covered with a polymer foil, and then it is set at a higher temperature to provide a flexible cement sheet, which is separated from said solid surface, in one embodiment together with the attached foil, and rolled up to be stored as rolls for future use. In a preferred embodiment, the cement sheet is reinforced by embedding into it a fiberglass mat or mesh, which may be unfolded before embedding from a roll. The composite panels exhibit high strength.

The process may employ a feed means for depositing the wet cement mixture upon said polymer foil or web. The mixture has a consistency of slurry or paste, which is uniformly spread onto the surface of a foil or a conveyor in a uniform layer, said foil and conveyor preferably moving like an endless tape having the desired width, such as 50-100 cm. The means may include a metering nozzle having a width slightly less than the width of said tape, and a spreading means providing a thin layer uniformly distributed on the tape, exhibiting a predetermined thickness, such as between 0.5 and 5 mm, for example 1-3 mm. The invention relates to a process providing composite building panels for an indoor or outdoor use, preferably in a continuous manner.

The invention provides a system for manufacturing slabs of foamed or extruded polymer coated on at least one side with a readymade flexible cement sheet, the sheet comprising inorganic materials, including hydraulic cement, sand, chalk, and additives, and a polymeric binder, preferably incorporated in the form of a latex, such as styrene-butadiene latex.

Cements are usually brittle, but the cement mixture of the invention is enough elastic to be rolled to form rolls to be stored, and used either immediately in a process of making composite panels, or preferably for future use. The cementitious material and the polymeric component are homogeneously combined to provide a solid sheet which, however, is enough strong and flexible to be bent and even rolled. The cement is prepared from a mixture comprising inorganic, preferably pozzolanic materials, and organic polymers, with additives ensuring strength and flexibility, including superplasticizer additives. After homogenizing, the shapeable, mortar-like mixture is extruded or poured onto a solid surface, optionally covered with a polymeric foil while adjusting the uniform thickness of the obtained layer, comprising extrusion, troweling, calendaring, rolling, etc. Usually, the process of mortar or cement preparation is quite complex, needs specific material ratios and takes up space and time, and may be cumbersome and messy; therefore, such process may extremely complicate production of mortar/cement coated slabs. The invention separates the process of producing the wet cement mortar and the process of coating the building slabs, while addressing most of the problems known in the field.

The invention will be further described and illustrated by the following examples.

### EXAMPLES

### Example 1

A wet cement mixture was prepared by homogenizing the following components (in weight percent): 51% Portland cement, 13% water, 13% quartz sand, 6.5% chalk, 13% binder latex purchased from EOC Belgium (styrene-butadiene emulsion L 6066, 48% solids), 0.25% antifoam, 0.25% thickener, 0.25% dispersant, 0.8% dioctylphthalate as superplasticizer, 0.9% perlite, and 0.4% wetting agent. The mixture was spread on a nonwoven polyester foil (PE) band to form a layer 2 mm thick, a fiberglass based web of the width about 1 mm was pushed into the wet mixture layer, the foil with the cement layer and fiberglass was placed in an oven at 125° C. for 8 minutes. A flexible cement layer was obtained, being enough strong to be peeled from the PE foil and enough flexible to be rolled without forming cracks.

### Example 2

A wet cement mixture was prepared by homogenizing the following components (in weight percent): 46% Portland cement, 19% water, 17% quartz sand, 5% chalk, 12% binder latex (styrene-acrylic copolymer emulsion), 0.2% antifoam, 0.2% thickener (cellulose), 0.2 superplasticizer, and 0.2% wetting agent. The mixture was spread on a nonwoven polyester foil (PE) band to form a layer 3 mm thick, a fiberglass based web of the width about 1 mm was pushed into the wet mixture layer, the foil with the cement layer and fiberglass was placed in an oven at 125° C. for 12 minutes. A flexible cement layer was obtained, enough firm and flexible to be peeled from the PE foil and rolled.

### Example 3

Glue was spread on a one side of a polystyrene (PS) slab 1 m×1 m, 0.8 cm thick, and two flexible cement sheet pieces, 50 cm×1 m, obtained according to Example 1, were pushed on the glue to cover one side of the PS slab to obtain a composite panel. The other side was glued and coated with the same flexible cement bands as the first side. The sandwich panel exhibited desired strength.

Some additional aspects of the invention may be related to intumescent layers. It has now been found that slabs or panels used in building construction can be provided with intumescent layers simply without employing intumescent components or wet raw materials, in a simple, health-friendly and environmentally friendly process, using readymade separate solid intumescent sheet, in any stage of the slabs production or installation. The system of the invention does with less working space and less complex manufacturing equipment than the known processes, while providing cost-effective results. The process of the invention precludes the problems with manipulating intumescent raw materials and with ungainly operation steps of applying the materials on the construction site, as well as problems with uneven deposition of the intumescent layer and difficulties about the maintenance of the equipment for delivery of intumescent slurries.

The invention provides a readymade separate intumescent sheet for simply coating any building construction element, comprising i) preparing a wet intumescent mixture by homogenizing components, such as for example ammonium polyphosphate, a polyol, a spumific agent, and additives selected from solvents, latexes, polymeric dispersions or emulsions, viscosity adjusters, dispersants, antifoams, surfactants, fillers, flexibility enhancers, preservatives, plasticizers, synergists, and dyes; ii) layering said mixture onto a reinforcing mat, the mat comprising materials selected from layers of organic or inorganic fibers, polymer webs, polymer films, chop strand mat, nonwoven fabrics, and fiberglass mat to form a layer of a thickness of about 0.5 to 5 mm; iii) optionally embedding in said wet layer another web or mat or foil; iv) moving said wet layer through an oven and drying said layer; and optionally v) attaching to the dried sheet, or lining said dried sheet with, another thin layer, either to finalize the mechanical or chemical properties of the sheet or to provide the sheet with an adhesive layer to be employed when attaching the sheet on the surface to be protected; thereby obtaining said intumescent sheet as a separate and readymade intumescent sheet to be immediately used or preferably stored for any future use.

In some embodiments, the additives may include agents simplifying the manufacturing process or improving the properties of the intumescent sheet, the former comprising for example dispersants or viscosity adjusters, the latter comprising for example flame-retarding adjusters or flexibility adjusters. Said synergists may include silicates, phyllosilicates, clays, fumes silica, vermiculite, metal oxides, and other known synergists. Of course, other known intumescent mixtures may be employed, for example comprising commercial pre-prepared mixtures, emulsions, and other combinations, usable as paste or spray or paint. The sheet for coating the surface of the construction elements may be a planar sheet of desired dimensions to be glued onto the surface of the same dimensions. The sheet is preferably a continuous flexible sheet, and the system and the process of the invention comprise a step of folding and rolling up said continuous flexible sheet to rolls for storage and future use, as well as a step of unfolding and gluing the sheet onto the surface. The process of the invention may provide planar sheets, or rolls of continuous sheet, of any desired and required dimensions.

One of the advantageous features of the invention is providing a separate flexible intumescent sheet, readymade for future use in coating building panels, walls, ceilings, beams, and columns. The coating may be performed on construction site or during the manufacture of the building elements. In a preferred embodiment, the flexible intumescent sheet is rolled up on rolls stable and ready for storage, transport and any future use, the sheet usually having a thickness of 0.5-5 mm, and being rolled as sheets for example 0.1-4 m wide, usually 0.2-3 m wide, such as 0.2-2 m wide, and up to 500 m long, such as 30-300 m long, for example 1 m wide and 100 m long.

The invention provides a process for manufacturing composite panels comprising slabs coated with one or two intumescent layers, comprising a step of gluing the readymade sheet of the invention onto the slabs. The slabs are combined with the sheet on one or both sides while employing glue between the polymer and the sheet, or other attaching means, including mechanical means. The invention provides, in one aspect, composite building panels, preferably in a continuous process comprising steps of spreading glue on the surface of the slab or the sheet and combining the slab and sheet, and cutting the composite panels to the desired size and packaging. The composite panels may comprise cement boards, plaster boards, gypsum boards and pa The invention thus provides a special product, process, and system, comprising a roll of flexible intumescent sheet which is formed by a) casting wet intumescent mixture with additives onto a reinforcing mat, b) drying, and c) rolling up the sheet by itself or on reels; the invention further provides a special process and system, comprising a step of unfolding the roll and attaching the readymade sheet onto building slabs or other surfaces including ceilings and walls, as well as columns and beams. The readymade intumescent sheet of the invention is advantageously employed for easy and cost-effective preparation of building surfaces coated with intumescent layer, the surfaces including cement boards, plaster boards, gypsum boards and gypsum panels. The process of the invention may comprise the step of attaching the intumescent sheet on the solid surface, or employing the readymade intumescent sheet as a base onto which additional construction layers are formed. In one embodiment, a wet mixture comprising cement, plaster materials or gypsum is layered on the readymade sheet, and the obtained slab is further processes by adding further layers or sheets or components. The system of the invention provides building construction elements provided with intumescent coating, including beams or columns; walls or ceilings; cladding for walls and ceilings; panels and slabs comprising metals, polymers, cartons, cements and plasters; cement boards, plaster boards, and gypsum boards.

Intumescent coatings can be usually formed from materials available in the market, such as in the form of paints or pastes for protecting the construction base from the heat of flame. The intumescent materials are applied as a thin layer by spreading or spraying on the surface of the construction elements. The exposure to fire makes the layer swell by creating a foam which insulates and protects the base, such as steel beams and columns. For example, steel starts to lose its strength at 300° C., and substantially at 500° C., and the intumescent coating may slower the temperature rise inside the steel construction and thus prevent or delay its collapse. The application of raw material mixtures onto large surfaces of the construction elements in situ is complicated, and the readymade sheet of the invention will immensely simplify the process. The invention provides a readymade intumescent flexible sheet having a thickness of 0.5 to 5 mm rolled up in cylinder rolls, to be applied and attached onto the surface of the construction elements to be protected from flame in accordance with the regulations. For example, the incorporation of the anti-flame protection into plaster panels nowadays requires substantial modification in their production process; the use of the sheet according to the invention will simplify the whole procedure. The intumescent sheet of the invention may be manufactured in a process comprising steps of i) creating a layer of an intumescent mixture on an reinforcing mat, wherein the mat may be placed on a carrier foil such as comprising PE, PP, PET, or other materials, ii) moving the mat and the layer through an oven and drying, and iii) rolling the dried layer and mat up to cylinder rolls of readymade flexible intumescent sheet to be applied anytime and anywhere else, wherein said dried layer and mat are peeled from the carrier foil when present before rolling up. The process may comprise a lining the sheet with an adhesive layer, optionally protected, for example with silicon-comprising paper.

The invention will be further described and illustrated by the following examples:

### Additional Example

### Example 4

An intumescent wet mixture was prepared by homogenizing 29% ammonium polyphosphate, 22% binder emulsion (vinyl acetate based copolymer), 12% pentaerythritol, 14% melamine, 10% titanium oxide, 6.6% water, 5% kaolin, 0.5% fibers, 0.3% preservative, 0.2% surfactant, 0.2% wetting agent, and 0.2% antifoam. The mixture was spread on a fiberglass mat to form a layer 2 mm thick, and the wet sheet was dried at a temperature of 110° C. A flexible intumescent sheet was obtained, which could be folded and rolled up without cracks in the intumescent layer.

According to additional aspects of the invention it has now been found that slabs or panels used in building construction can be provided with thermo-insulating layers simply without employing thermo-insulating components or wet raw materials, in a simple, health-friendly and environmentally friendly process, using readymade separate solid thermo-insulating sheet, in any stage of the slabs production or installation. The system of the invention does with less working space and less complex manufacturing equipment than the known processes, while providing cost-effective results. The process of the invention precludes the problems with manipulating thermo-insulating raw materials and with ungainly operation steps of applying the materials on the construction site, as well as problems with uneven deposition of the thermo-insulating layer and difficulties about the maintenance of the equipment for delivery of thermo-insulating suspensions or slurries.

The invention provides a readymade separate thermo-insulating sheet for simply coating any building construction element, comprising i) preparing a wet thermo-insulating mixture by homogenizing the required components, comprising solvents, polymeric latexes, and additives, selected from viscosity adjusters, dispersants, antifoams, surfactants, fillers, flexibility enhancers, preservatives, plasticizers, synergists, and dyes; ii) layering said mixture onto a reinforcing mat, the mat comprising materials selected from layers of organic or inorganic fibers, polymer webs, polymer films, chop strand mat, nonwoven fabrics, and fiberglass mat to form a layer of a thickness of about 0.2 to 4 mm; iii) optionally embedding in said wet layer another web or mat or foil; iv) moving said wet layer through an oven and drying said layer; and optionally v) attaching to the dried sheet, or lining said dried sheet with, another thin layer, either to finalize the mechanical or chemical properties of the sheet or to provide the sheet with an adhesive layer to be employed when attaching the sheet on the surface to be protected; thereby obtaining said thermo-insulating sheet as a separate and readymade thermo-insulating sheet to be immediately used or preferably stored for any future use. Said additives may include agents simplifying the manufacturing process or improving the properties of the thermo-insulating sheet, the former comprising for example dispersants or viscosity adjusters, the latter comprising for example flexibility adjusters. The wet thermo-insulating mixture may comprise silicates, phyllosilicates, clays, fumes silica, vermiculite, metal oxides, and other metal oxides. Of course, commercial pre-prepared mixtures, emulsions, and other combinations, usable as paste or spray or paint, may be included. The sheet for coating the surface of the construction elements may be a planar sheet of desired dimensions to be glued onto the surface of the same dimensions. The sheet is preferably a continuous flexible sheet, and the system and the process of the invention comprise a step of folding and rolling up said continuous flexible sheet to rolls for storage and future use, as well as a step of unfolding and gluing the sheet onto the surface. The process of the invention may provide planar sheets, or rolls of continuous sheet, of any desired and required dimensions.

One of the advantageous features of the invention is providing a separate flexible thermo-insulating sheet, readymade for future use in coating building panels, walls, ceilings, beams, and columns. The coating may be performed on construction site or during the manufacture of the building elements. In a preferred embodiment, the flexible thermo-insulating sheet is rolled up on rolls stable and ready for storage, transport and any future use, the sheet usually having a thickness of 0.2-4 mm, and being rolled as sheets for example 0.1-4 m wide, usually 0.2-3 m wide, such as 0.2-2 m wide, and up to 500 m long, such as 30-300 m long, for example 1 m wide and 100 m long.

The invention provides a process for manufacturing composite panels comprising slabs coated with one or two thermo-insulating layers, comprising a step of gluing the readymade sheet of the invention onto the slabs. The slabs are combined with the sheet on one or both sides while employing glue between the polymer and the sheet, or other attaching means, including mechanical means. The invention provides, in one aspect, composite building panels, preferably in a continuous process comprising steps of spreading glue on the surface of the slab or the sheet and combining the slab and sheet, and cutting the composite panels to the desired size and packaging. The composite panels may comprise cement boards, plaster boards, gypsum boards and panels.

mixture with additives onto a reinforcing mat, b) drying, and c) rolling up the sheet by itself or on reels; the invention further provides an advantageous novel process and system, comprising a step of unfolding the roll and attaching the readymade sheet onto building slabs or other surfaces including ceilings and walls, as well as columns and beams. The readymade thermo-insulating sheet of the invention is advantageously employed for easy and cost-effective preparation of building surfaces coated with thermo-insulating layer, the surfaces including cement boards, plaster boards, gypsum boards and gypsum panels. The process of the invention may comprise the step of attaching the thermo-insulating sheet on the solid surface, or employing the readymade thermo-insulating sheet as a base onto which additional construction layers are formed.

In one embodiment, a wet mixture comprising cement, plaster materials or gypsum is layered on the readymade sheet, and the obtained slab is further processes by adding further layers or sheets or components. The system of the invention provides building construction elements provided with thermo-insulating coating, including beams or columns; walls or ceilings; cladding for walls and ceilings; panels and slabs comprising metals, polymers, cartons, cements and plasters; cement boards, plaster boards, and gypsum boards.

Thermo-insulating coatings of the invention can be formed from known components exhibiting thermal protecting effects or from readymade mixtures available in the market, such as in the form of paints or pastes for protecting the construction base from heat. However, the application of raw material mixtures onto large surfaces of the construction elements in situ according to known methods is complicated, and the readymade sheet of the invention will immensely simplify the process. The invention provides a readymade thermo-insulating flexible sheet having a thickness of 0.2 to 4 mm rolled up in cylinder rolls, to be applied and attached onto the surface of the construction elements to be protected from flame in accordance with the regulations.

For example, the incorporation of the anti-flame protection into plaster panels nowadays requires substantial modification in their production process; the use of the sheet according to the invention will simplify the whole procedure. The thermo-insulating sheet of the invention may be manufactured in a process comprising steps of i) creating a layer of a thermo-insulating mixture on an reinforcing mat, wherein the mat may be placed on a carrier foil such as comprising PE, PP, PET, or other materials, ii) moving the mat and the layer through an oven and drying, and iii) rolling the dried layer and mat up to cylinder rolls of readymade flexible thermo-insulating sheet to be applied anytime and anywhere else, wherein said dried layer and mat are peeled from the carrier foil when present before rolling up. The process may comprise a lining the sheet with an adhesive layer, optionally protected, for example with silicon-comprising paper.

The thermo-insulating mixture for use according to the invention usually comprises dried polymeric latex, often acrylic based. An acrylic elastomeric emulsion is employed in preparing wet mixtures for making the sheet of the invention, containing nano-sized particles, preferably comprising beside polymeric latex particles, usually dispersed in water, also inorganic particles such as metal oxides, commercially available or produced by ultrasonicating a suspension of metal oxides and water. The nanoparticles may comprise titanium oxide, silicon oxide, zinc oxide, and others. Other special materials known in the art may be employed in the preparation of the wet mixture for manufacturing the thermo-insulating sheet of the invention, including, for example, hollow glass microspheres, sepiolite nanofibers, and others.

The particles block heat transfer in the final dried layer, reflect thermal radiation, and preferably also create a moisture barrier. The final protecting layer, preferably white, exhibits good thermal radiation reflectance and heat transfer resistance (heat transfer resistance is he reciprocal of heat conductance). The sheet of the invention usually exhibits thermal reflectance, in the infrared region of light of between 700-2200 nm, of 70% or more, for example 80% or more, such as 85% or more, such as 90% or more, such as 92% or more, such as 94% or more. Thermal insulating effect of a thermo-insulating sheet of the invention can be checked by thermography, for example by heating board samples from backside with infrared lamp and comparing changes of temperature at the front side; the highest reached temperature at the front side may be lower by at least 3° C., such as at least 5° C., for the board coated with the sheet of the invention, compared to the board sample of the same dimensions without the sheet. Thermal conductivity of a board sample or model panel coated with the sheet of the invention is lower than a panel of the same dimensions without the sheet, the difference may be at least 0.2 W·K⁻¹m⁻², such as at least 0.3 W·K⁻¹m⁻², such as at least 0.4 W·K⁻¹m⁻², such as at least 0.5 W·K⁻¹m⁻².

The sheet of the invention creates a thermal blanket on the surface of the building construction elements which, moreover, is resistant to water, as well as to fungi and algae. The dry heat-insulating layer on the sheet of the invention is enough flexible to be rolled up, and maintains its elasticity over a wide range of temperature changes, thereby ensuring the needed robustness and long-term effects.

The effects of radiation and conduction, contributing most to the heat transfer in buildings, are both reduced by the sheet of the invention; the sheet exhibits enhanced reflectivity, thereby bouncing back the incoming radiation, and reduced heat conductivity, thereby blocking the heat transfer between the exterior and interior of the building.

The thermo-insulating sheet of the invention is advantageously employed for coating external surfaces, internal surfaces, walls, ceilings, masonry, concrete, cement plates, plaster board, building panels, as well as any building construction elements, thereby slowing down the heat transfer, for example from inside to outside when heating in the winter or from outside to inside when cooling in the summer. The treated surfaces may include horizontal and vertical surfaces as well, the surfaces comprising concrete, cement, mortar, asphalt, but also metals, plastics, cellulosic materials or wood.

The method according to the invention for producing the thermo-insulating sheet employs a wet mixture for making the final dry thermo-insulating layer, which wet mixture may comprise commercially available thermal insulating materials, including paints, examples including products of company NanoPhos SA or NanoSilv S.r.l.

The method and system of the invention for reducing the thermal conductance of the building elements enable to avoid complexities of wet paint application, to obviate weather interferences, to prevent contaminations of the working space with wet paint, and to preclude waiting for paint drying/ curing/ stabilization which may take hours or days.

The invention will be further described and illustrated by the following example.

### Example 5

SurfaPaint ThermoDry of NanoPhos was sprayed onto a fiberglass mat to form a layer of 1 mm thick, and the wet sheet was dried at a temperature of 120° C. A flexible thermo-insulating sheet was obtained, which could be folded and rolled up without cracks in the thermo-insulating layer.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A continuous flexible cement sheet roll for coating construction slabs, the continuous flexible cement sheet roll comprising a cement layer having a thickness of between 0.5 and 5 mm and comprising inorganic mortar and up to 15% polymeric binder.

2. The flexible cement sheet roll of claim 1, further comprising a reinforcing layer of: a thickness lower than the thickness of said cement layer, selected from a film of a nonwoven fabric, a layer of organic or inorganic fibers, a polymer web, chop strand mat, and fiberglass mat.

3. The flexible cement sheet roll of claim 1, further comprising a polymeric foil which lines said cement layer.

4. The flexible cement sheet roll of claim 1, wherein said cement layer comprises
i) hydraulic cement;
ii) sand;
iii) water;
iv) polymeric binder; and
v) up to 10% additives selected from thickeners, fillers, plasticizers, surfactants, dispersants, antifoams, rheology affecting agents, hydrophobicity adjusting agents, and flame retardants (FRs).

5. The flexible cement sheet roll of claim 1, wherein said cement layer comprises
i) 40-70% hydraulic cement;
ii) 10-25% sand;
iii) up to 10% chalk or calcium carbonate;
iv) 5-15% water;
v) 5-15% polymeric binder; and
vi) up to 5% additives selected from thickeners, fillers, plasticizers, surfactants, dispersants, antifoams, rheology affecting agents, hydrophobicity adjusting agents, and flame retardants (FRs).

6. The flexible cement sheet roll of claim 1, wherein said cement layer comprises
i) 50-60% hydraulic cement of Portland types;
ii) 13-23% quartz sand;
iii) 5-9% chalk or calcium carbonate;
iv) 8-12% water;
v) 5-9% polymeric binder comprising agents selected from acrylates, styrene acrylic copolymers, styrene and butadiene copolymers, epoxy resins, methyl methacrylate, unsaturated polyester resins, polyurethane, and vinyl esters; and
vi) 0.5-5% additives selected from thickeners, fillers, plasticizers, surfactants, dispersants, wetting agents, antifoams, rheology affecting agents, hydrophobicity adjusting agents, and flame retardants (FRs).

7. The flexible cement sheet roll of claim 1, further comprising a reinforcing layer comprising fiberglass embedded in said flexible cement sheet roll.

8. The flexible cement sheet roll of claim 1, further comprising a polymeric foil which lines said flexible cement sheet roll, the foil comprising a nonwoven fabric.

9. The flexible cement sheet roll of claim 1, for coating construction elements including foamed or extruded polymeric slabs, polystyrene or polyurethane panels, carton slabs, or slabs comprising mineral or organic fibers, said flexible cement sheet roll comprising a cement layer of a uniform thickness of between 1 and 4 mm, optionally a reinforcing layer embedded in said cement sheet roll, and optionally a polymeric foil lining said cement sheet roll, wherein said flexible cement sheet roll has a width of 0.2-2 m, and said flexible cement sheet roll has a length of 50-300 m.

10. A process for manufacturing a continuous flexible cement sheet roll for coating construction elements, the process comprising
i) preparing a cement mortar mixture by homogenizing hydraulic cement, sand, water, 5-15% polymeric binder added to the mixture with a solvent as a fine dispersion, and up to 10% additives comprising agents selected from plasticizers, superplasticizers, antifoams, thickeners, fillers, dispersants, and viscosity adjusting agents;
ii) layering said cement mortar mixture onto a heat-resistant surface of a conveyor, the surface optionally covered by a polymeric foil, thereby forming a wet cement mortar layer of a thickness of from 0.5 to 5 mm;
iii) optionally embedding in said wet cement mortar layer a reinforcing layer of a thickness lower than the thickness of said wet cement mortar layer, selected from a film of a nonwoven fabric, a layer of organic or inorganic fibers, a polymer web, chop strand mat, and fiberglass mat;
iv) moving said heat resistant surface, optionally with said polymeric foil, bearing said wet cement mortar mixture, optionally with said reinforcing layer, through an oven set at 110-140° C. in which said wet cement mixture sets, thereby forming a flexible solid layer;
v) peeling said flexible solid layer, optionally with said polymeric foil attached to said flexible layer and lining said flexible layer, from said heat resistant surface, thereby obtaining said continuous flexible cement sheet; and
vi) rolling said flexible cement sheet up, thereby obtaining a roll of readymade continuous separate cement sheet for immediate or future use in coating construction elements, wherein
the continuous sheet is strong and flexible enough to be unfolded and glued on at least one surface of said construction elements, the elements including foamed or extruded slabs, polystyrene or polyurethane panels, carton slabs, slabs comprising mineral or organic fibers, and metal columns or beams.

11. The process of claim 10, further comprising
i) preparing said homogeneous cement mortar mixture by mixing 35-60% hydraulic cement, 8-20% quartz sand, up to 8% of chalk or calcium carbonate, 15-30% water, 5-15% polymeric binder added to the mixture as a concentrated fine dispersion, and up to 4% additives comprising agents selected from plasticizers, superplasticizers, antifoams, thickeners, fillers, dispersants, surfactants, dispersants, rheology affecting agents, hydrophobicity adjusting agents, FRs, dioctylphthalate, aluminum hydroxide, magnesium hydroxide, cellulose, nylon, fume silica, perlite, vermiculite, glass, PP, basalt, preservatives, and dyes;
ii) layering said cement mortar mixture onto said heat-resistant surface, the surface comprising a Teflon surface of a belt conveyor 0.2-2 m wide, optionally covered with said polymeric foil;
iii) optionally embedding said reinforcing layer in said wet cement mortar layer, the reinforcing layer comprising fiberglass;
iv) moving said heat resistant surface bearing said wet cement mixture optionally with said reinforcing layer into an oven set at 120-130° C., in which said wet cement mortar mixture sets to form said flexible solid layer;
v) peeling said layer from said foil, optionally together with said polymeric foil which becomes an integral part of the produced flexible sheet, thereby obtaining said continuous flexible cement sheet;
vi) rolling said flexible sheet up, thereby obtaining a roll of continuous cement sheet having a length of 20-200 m for immediate use or for storing for a future use;
the continuous sheet being enough strong and flexible to be unfolded and glued onto the surface of said construction elements, including foamed and extruded slabs, polystyrene or polyurethane panels, carton slabs, slabs comprising mineral or organic fibers, and metal columns or beams.

12. The process of claim 10, wherein said step iv) is performed in a continuous manner or in a batch manner.

13. The process of claim 10, wherein said polymeric foil is selected from nonwoven fabric webs.

14. A process for manufacturing a construction composite panel comprising a polymer slab core and a cement coat at least on one side of the slab, the process comprising:
i) preparing a cement mortar mixture by homogenizing hydraulic cement, sand, water, 5-15% polymeric binder added to the mixture as a fine dispersion, and up to 10% additives comprising agents selected from plasticizers, superplasticizers, antifoams, thickeners, fillers, dispersants, and viscosity adjusting agents;
ii) casting said cement mortar mixture onto a heat-resistant surface of a conveyor, the surface optionally covered by a polymeric foil, thereby forming a wet cement mortar layer of a thickness of from 0.5 to 5 mm;
iii) optionally embedding a reinforcing layer of a thickness lower than the thickness of said wet cement mortar layer, selected from a film of a nonwoven fabric, a layer of organic or inorganic fibers, a polymer web, chop strand mat, and fiberglass mat, in said wet cement mortar layer;
iv) setting cement mortar layer by exposing it to a temperature of 110-140° C., in a continuous or in a batch manner, thereby providing a solid and flexible cement layer;
v) peeling said flexible cement layer, optionally with said polymeric foil, thereby obtaining a continuous flexible cement sheet;
vi) folding the sheet to provide a roll of separate readymade flexible cement sheet;
vii) applying glue on one side of said slab core or on one side of said flexible cement sheet after unfolding from the coil, and pressing said cement sheet onto said core, thereby obtaining a composite panel coated on one side;
viii) optionally gluing said flexible cement sheet on the second side of said slab, thereby obtaining a sandwich building composite panel; and
ix) clearing and cutting the coated slab to desired shape and size;
thereby obtaining structure elements coated on one or two sides, including sandwich-structured polystyrene panels coated on both sides.

15-44. (canceled)

45. A structural element comprising a polystyrene panel coated on one or both sides by the flexible cement sheet roll of claim 1.

46. A structural element comprising a polystyrene panel coated on one or both sides by the flexible cement sheet roll of claim 4.

47. A structural element comprising a polystyrene panel coated on one or both sides by the flexible cement sheet roll of claim 5.

48. A structural element comprising a polystyrene panel coated on one or both sides by the flexible cement sheet roll of claim 6.
